(19) United States
(12) Patent Application Publication
(10) Pub. No.: US 2014/0075569 A1
(43) Pub. Date: Mar. 13, 2014

(54) DISPLAY APPARATUS AND DISPLAY PROGRAM

(71) Applicant: SAMSUNG ELECTRONICS CO., LTD., Suwon-si (KR)

(72) Inventor: Takashi SUDO, Yokohama-shi (JP)

(21) Appl. No.: 14/023,833

(22) Filed: Sep. 11, 2013

(30) Foreign Application Priority Data
Sep. 11, 2012 (JP) 2012-199829
Jun. 20, 2013 (KR) 10-2013-0071157

(51) Int. Cl. G06F 21/60

(52) U.S. Cl. CPC G06F 21/60
USPC 726/27

(57) ABSTRACT

Provided are a display apparatus and a display program that may prevent data for personal use from becoming known to a third party, when the third party unexpectedly appears while a user is using the display apparatus. The display apparatus includes a display unit configured to display a screen based on specific data of a specific user for personal use; a detection unit configured to detect a person and determine whether the detected person is the specific user or a third party other than the specific user; and a display control unit configured to convert the screen of the display unit into a screen hiding the specific data when the third party is detected by the detection unit.

### RELATED APPLICATIONS

This application claims the benefit of Japanese Patent Application No. 2012-199829, filed on Sep. 11, 2012, in the Japanese Intellectual Property Office, and Korean Patent Application No. 10-2013-0071157, filed on Jun. 20, 2013, in the Korean Intellectual Property Office, the disclosures of which are incorporated herein by reference in their entirety.

### BACKGROUND

1. Field

Apparatuses and methods consistent with exemplary embodiments relate to providing a display apparatus and a display program.

2. Description of the Related Art

Televisions (TVs) are watched by many people and are commonly used as home appliances. Recently, TVs of the related art have increasingly incorporated various features and thus have been increasingly used for various purposes. Accordingly, TVs may be personal use apparatuses that manage specific data for personal use. Therefore, protecting the privacy of each user that personally uses a TV has become increasingly important.

In the related art, a technology is being developed that may be used to protect user privacy when a user is using a navigation apparatus of a car. For example, Japanese Patent Publication No. 2009-88960 discloses a technology that may display different contents depending on whether or not there is a third party, other than a specific user, present. Specifically, when there is an incoming phone call, if a third party is not in the car, a name or a phone number of a caller is displayed. However, if a third party is in the car, only information indicating that an incoming call has arrived is displayed. Accordingly, the privacy of each user using the navigation apparatus may be protected.

The technology disclosed in Japanese Patent Publication No. 2009-88960 is based on a premise that the technology is used in a car. Thus, while a navigation apparatus of a car is being used, a new third party may not be present.

In the related art, when a TV is used in an environment where third parties may access, a third party may appear while a user is watching TV that is displaying specific data for personal use. Accordingly, the specific data for personal use may become known to the third party.

### SUMMARY

Exemplary embodiments address at least the above problems and/or disadvantages and other disadvantages not described above. Also, the exemplary embodiments are not required to overcome the disadvantages described above, and an exemplary embodiment may not overcome any of the problems described above.

One or more exemplary embodiments a display apparatus and a display program that may prevent specific data for personal use from becoming known to a third party, even when the third party unexpectedly appears while a user is using the TV.

According to an aspect of an exemplary embodiment, there is provided a display apparatus including: a display unit that is configured to display a screen based on specific data of a specific user for personal use; a detection unit configured to detect a person and determine whether the detected person is the specific user or a third party other than the specific user; and a display control unit configured to convert the screen of the display unit into a screen hiding the specific data when the third party is detected by the detection unit.

The display apparatus may further include a data management unit configured to manage the specific data for personal use, according to users that have used the display apparatus.

The detection unit may register in advance a user that corresponds to the specific use, and determine all non-registered users as the third party.

When the third party is no longer detected by the detection unit, the display control unit is configured to return the screen of the display unit to a state existing just before the third party was detected.

When the specific user that had been detected by the detection unit is no longer detected, the display control unit is configured to convert the screen of the display unit into the screen hiding the specific data.

When the specific user returns and is detected by the detection unit, the display control unit is configured to convert the screen of the display unit from the screen hiding the specific data into a screen not hiding the specific data.

The display control unit may gradually convert the screen of the display unit into the screen hiding the specific data according to a distance between the third party and the display apparatus.

The display control unit may convert a login state in a specific application or a specific site into one that appears as a logout state, and thus may convert the screen of the display unit into the screen hiding the display data.

The specific data may include at least one of operation history, watching history, view history, a web page being displayed, a content being watched, an application being used, a recorded content being reproduced, and personal information.

The display apparatus may further include a plurality of tuners.

When the screen of the display unit is being converted into the screen hiding the specific data, the display control unit is configured to hide the specific data by displaying a digital broadcast of a channel that is tuned by a tuner other than a tuner of the digital broadcast that is being displayed.

According to an aspect of another exemplary embodiment, there is provided a non-transitory computer readable medium storing a display program which, when executed by a computer that functions as a display apparatus that displays a screen based on specific data of a specific user for personal use, performs a method including: detecting a person and determining whether the detected person is the specific user or a third party other than the specific user; and when the third party is detected, converting the screen of the display unit to a display hiding the specific data.

The detecting of the specific user and the third party may be determined regardless of whether an instruction for displaying the specific data for personal use is provided, and a microphone may be used to determine whether the third party other than the specific user is approaching the display apparatus.

In the converting of the screen, when the third party is no longer detected in the detecting of the specific user and the third party, the screen of the display apparatus is returned to a state existing just before the third party is detected.

In the converting of the screen, when the specific user that had been detected in the detecting of the specific user and the third party is no longer detected, the screen of the display apparatus is converted into the screen hiding the specific data.

In the converting of the screen, when the specific user returns and is detected in the detecting of the specific user and the third party, the screen of the display apparatus is converted into a state existing just before the specific user was not detected.

In the converting of the screen, the screen of the display unit may be converted to the screen hiding the specific data according to a distance between the third party and the display apparatus.

In the converting of the screen, a login state in a specific application or a specific site may be converted to one that appears as a logout state, and thus the screen of the display unit is converted into the screen hiding the specific data.

The specific data may include at least one of operation history, watch history, view history, a web page being displayed, a content being watched, an application being used, a recorded content being reproduced, and personal information.

The display apparatus may include a plurality of tuners.

In the converting of the screen, when the screen of the display apparatus is being converted into the screen hiding the specific data, the specific data may be hidden by displaying a digital broadcast of a channel that is tuned by a tuner other than a tuner of the digital broadcast that is being displayed.

According to an aspect of another exemplary embodiment, there is provided a method of protecting personal data of a specific user that is displayed on a display device, the method including: displaying the personal data of the specific user on the display device when a third party is not present; and hiding the personal data of the specific user on the display device when the third party is present.

The specific user may be at least one of a user that is present when the display device is turned on and a registered user.

The method may further include: displaying public data on the display device; receiving a request to display the personal data of the specific user on the display device; and displaying the public data and the personal data on the display device.

The method may further include: detecting a person approaching the display device; partially hiding the personal data displayed on the display device; determining if the detected person is the specific user or the third party; and returning the display to a state that existed right before the person was detected or hiding the personal data displayed on the display device based on a result of the determination.

Partially hiding the personal data displayed on the display device may include converting an area of a screen of the display device where the personal data displayed into a translucent screen.

Hiding the personal data displayed on the display device may include displaying only public data.

The personal data may include at least one of operation history, watch history, view history, a web page being displayed, a content being watched, an application being used, a recorded content being reproduced, and personal information.

### BRIEF DESCRIPTION OF THE DRAWINGS

These and/or other aspects will be more apparent by describing certain exemplary embodiments with reference to the accompanying drawings, in which:

FIG. 1 is a block diagram illustrating a schematic configuration of a display apparatus according to an exemplary embodiment;

FIG. 2 is a block diagram illustrating an example of a hardware configuration of a control unit according to an exemplary embodiment;

FIG. 3 is a flowchart of an order of a screen conversion process according to an exemplary embodiment;

FIG. 4 is a screen example 1 (public mode) in which a display is converted according to the screen conversion process;

FIG. 5 is a screen example 2 (alert mode) in which a display is converted according to the screen conversion process;

FIG. 6 is a screen example 3 (screen being converted) in which a display is converted according to the screen conversion process;

FIG. 7 is a screen example 4 (privacy protection mode) in which a display is converted according to the screen conversion process;

FIG. 8 is a modified example 1 of the screen example 3 (converting screen) according to an exemplary embodiment;

FIG. 9 is a modified example 1 of the screen example 4 (privacy protection mode) according to an exemplary embodiment;

FIG. 10 is a modified example 2 of the screen example 3 (screen being converted) according to an exemplary embodiment; and

FIG. 11 is a modified example 2 of the screen example 4 (privacy protection mode) according to an exemplary embodiment.

### DETAILED DESCRIPTION OF THE EXEMPLARY EMBODIMENTS

Certain exemplary are described in greater detail with reference to the accompanying drawings.

In the following description, like drawing reference numerals are used for the same elements, even in different drawings. Also, sizes and ratios in the drawings are exaggerated for clarity, and thus may be different from the actual sizes and ratios.

The matters defined in the description, such as detailed construction and elements, are provided to assist in a comprehensive understanding of the exemplary embodiments. However, the exemplary embodiments can be practiced without those specifically defined matters. Also, well-known functions or constructions are not described in detail since they would obscure the exemplary embodiment with unnecessary detail.

As used herein, expressions such as “at least one of,” when preceding a list of elements, modify the entire list of elements and do not modify the individual elements of the list.

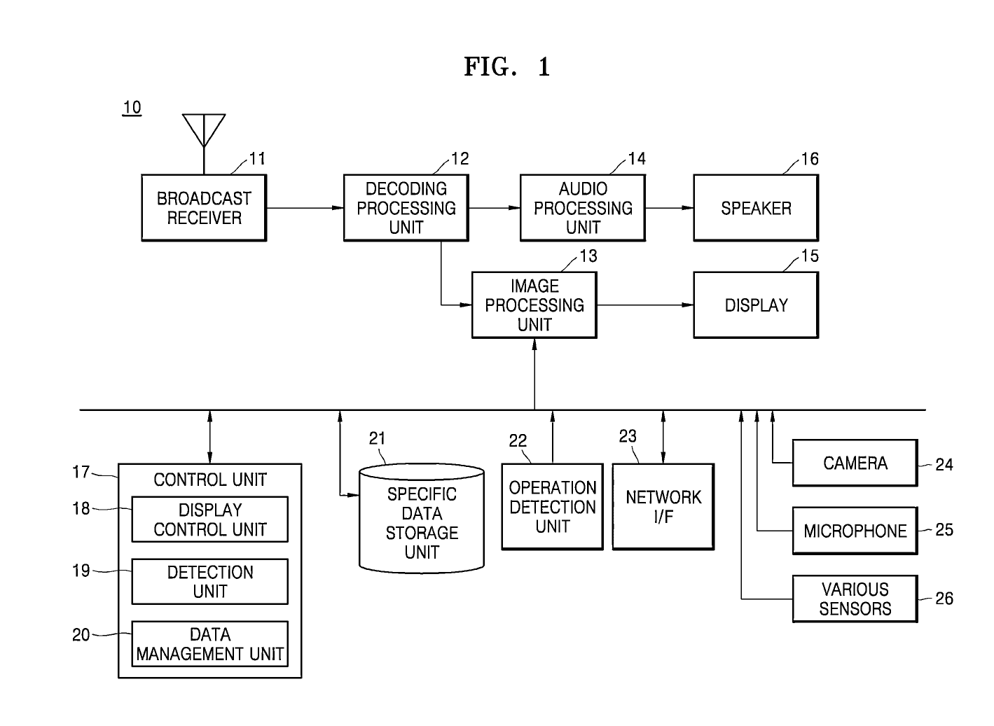

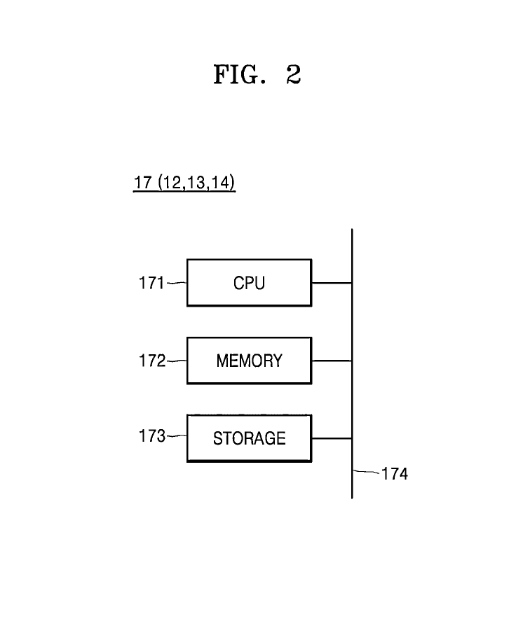

FIG. 1 is a block diagram illustrating a schematic configuration of a display apparatus 10 according to an exemplary embodiment. FIG. 2 is a block diagram illustrating an example of a hardware configuration of a control unit 17 according to an exemplary embodiment.

Hereinafter, the schematic configuration of the display apparatus 10 will be described with reference to FIGS. 1 and 2.

The display apparatus 10 is a TV that may receive digital broadcast and display broadcasting programs on a display, such as a liquid crystal display (LCD). In general, a TV may be installed in a home and used in shared rooms, e.g., living rooms, where they are watched simultaneously by many people. Accordingly, the TV may be classified as a home appliance.

As illustrated in FIG. 1, the display apparatus 10 includes a broadcast receiver 11, a decoding processing unit 12, an image processing unit 13, an audio processing unit 14, a display 15, a speaker 16, the control unit 17, a specific data storage unit 21, an operation detection unit 22, a network interface 23, a camera 24, a microphone 25, and various sensors 26. The elements may be connected to each other by buses for exchanging signals.

The broadcast receiver 11 may include an antenna, a tuner, and a demodulator (not shown). The antenna is used for digital terrestrial broadcast or digital satellite broadcast, and receives broadcasted radio waves transmitted from a broadcasting station. The tuner tunes a broadcast signal of a desired channel among broadcast signals, such as a digital terrestrial broadcast, a digital satellite broadcast, and a cable TV broadcast. The tuner may include a plurality of tuner units, and may simultaneously receive a plurality of broadcasts. The demodulator demodulates according to a modulation type of each digital broadcast. For example, the digital terrestrial broadcast is demodulated into moving picture experts group-transport stream (MPEG-TS) data by using an orthogonal frequency division multiplexing (OFDM) demodulation method. Also, the digital satellite broadcast is demodulated into MPEG-TS data by using a phase shift keying (PSK) demodulation method.

The decoding processing unit 12 may be an MPEG decoder, or an image/audio decoder. The decoding processing unit 12 sectionalizes and then decodes MPEG-TS data, which is a result of demodulation by the demodulator of the broadcast receiver 11. For example, the decoding processing unit 12 generates image data and audio data by converting an image elementary stream (ES) into an image packetized elementary stream (PES), and converting an audio ES into an audio PES.

The image processing unit 13 converts image data generated in the decoding processing unit 12 into a format (e.g., number of pixels, frame frequency, scanning method) that is displayable on the display 15, and displays the converted image data on the display 15. Also, the image processing unit 13 may overlap digital data that is acquired via the Internet with the image data from the decoding processing unit 12, and displays the overlapped data on the display 15. The digital data may be acquired through the internet by using a general personal computer (PC). The digital data may include data such as web pages, image data, video data, streaming data, or various application data.

The audio processing unit 14 converts the audio data generated in the decoding processing unit 12 into audio data that is reproducible by using the speaker 16, and then reproduces the audio data via the speaker 16.

The display 15 displays the data generated in the image processing unit 13, that is, the image data, based on the received broadcast signals, or the digital data that is acquired via the Internet. The display 14 may be an LCD or an organic light-emitting diode (OLED) display apparatus.

The speaker 16 outputs audio signals that are generated by the audio processing unit 14.

The control unit 17 controls the entire display apparatus 10. The control unit 17 includes a display control unit 18, a detection unit 19, and a data management unit 20.

The display control unit 18 controls a display in the display 15. For example, the display control unit 18 may execute a batch control process to control the broadcast receiver 11, the decoding processing unit 12, and the image processing unit 13, and controls the display 15 to display a digital broadcast transmitted from a broadcasting station. Also, the display control unit 18 may acquire various digital data that is provided on the Internet through the network interface 23, and may control the display 15 to display the acquired data.

The data displayed on the display 15 may include personal use data for a specific user (hereinafter, referred to as “specific data”). For example, the specific data may include data for using social network service (SNS), data for an Internet phone service, personal use images or videos, operation history, login information regarding specific services, keyword input history, search history in search sites, view history of web pages, personal information, such as credit card numbers or passwords, etc. If a third party suddenly appears while the specific data is displayed on the display 15, the specific data may become known to the third party. Therefore, when a third party is detected, the display control unit 18 converts a screen into a screen that hides the specific data.

The detection unit 19 detects a person that is near the display apparatus 10, then, distinguishes a user using the display apparatus 10 (hereinafter, referred to as “specific user), that is, a user watching a digital broadcast, from a third party other than the specific user. For example, if a person is near the display apparatus 10 while a digital broadcast is displayed, the detection unit 19 determines that the person is the specific user. On the other hand, if another person is detected near the display apparatus 10 after the specific user is detected, then the detection unit 19 determines that the other person is a third party. However, a method of distinguishing the specific user from the third party is not limited thereto. For example, all users that may be specific users may be registered in the display apparatus 10 in advance, and all non-registered users may be determined to be the third party.

The data management unit 20 manages the specific data according to users that have used the display apparatus 10. For example, the data management unit 20 organizes and then manages data such as data for using SNS, data for an Internet phone service, personal use images or videos, operation history, login information regarding specific services, keyword input history, search history in search sites, view history of web pages, personal information, such as credit card numbers or passwords, etc., according to users.

The specific data storage unit 21 stores the specific data.

The operation detection unit 22 receives operation signals transmitted from an operation device (not shown), and thus detects an operation performed by a user. The operation device may be a remote control, wired or wireless keyboards using radio communication via infrared light or Bluetooth®, etc.

The network interface 23 is an interface for communicating with an external device (for example, a server providing web pages or various applications) via a network. A standard such as Ethernet®, token ring, or fiber distributed data interface (FDDI) may be used.

The camera 24 is a general photographing apparatus that photographs the front of the specific user (e.g., a face) or a third party other than the specific user that is watching a digital broadcast.

The microphone 25 acquires audio such as sound or footsteps of a third party other than the specific user that is watching a digital broadcast.

The various sensors 26 include sensors such as an infrared camera, an infrared thermography, or a human detection sensor, and are used to detect the specific user or a third party that is watching a digital broadcast.

The control unit 17 controls the display apparatus 10 by using a central processing unit (CPU) 171. That is, the CPU 171 temporarily stores an operating system (OS) or a program, which is installed in a storage 173, in the memory 172; reads the OS and the program from the memory 172; and then, executes the OS and the program.

As shown in FIG. 2, the CPU 171, memory 172, storage 173 are connected to each other by a bus 174 to exchange signals.

The CPU 171 is a control circuit that includes a multi-core processor that controls each unit or executes various operation processes according to programs. Each feature of the control unit 17 is performed by the CPU 171 to execute a program that corresponds to each feature of the control unit 17.

The memory 172 may be a primary storage device with high speed access that temporarily stores a program and data. The memory 172 may be dynamic random access memory (DRAM), synchronous dynamic random access memory (SDRAM), or static random access memory (SRAM).

The storage 173 is a mass auxiliary storage device that stores various programs or data, including an OS. The storage 173 may be a flash memory, a solid state drive, or a hard disc.

The decoding processing unit 12, the image processing unit 13, and the audio processing unit 14 use the CPU 171 to process signals. That is, the CPU 171 reads an OS or a program, which is installed in the storage 173, from the memory 172, and then, executes the OS or the program. However, the exemplary embodiments are not limited thereto. The elements may use an exclusive hardware circuit other than the CPU 171.

The specific data storage unit 21 is implemented by using the storage 173.

Hereinafter, an operation of the display apparatus 10 will be described.

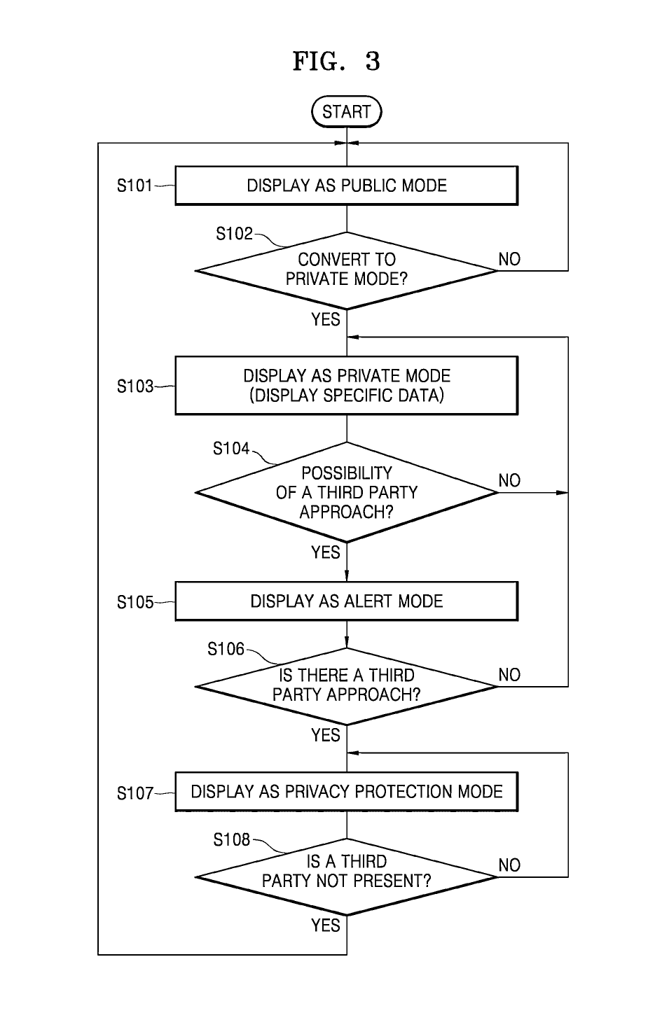

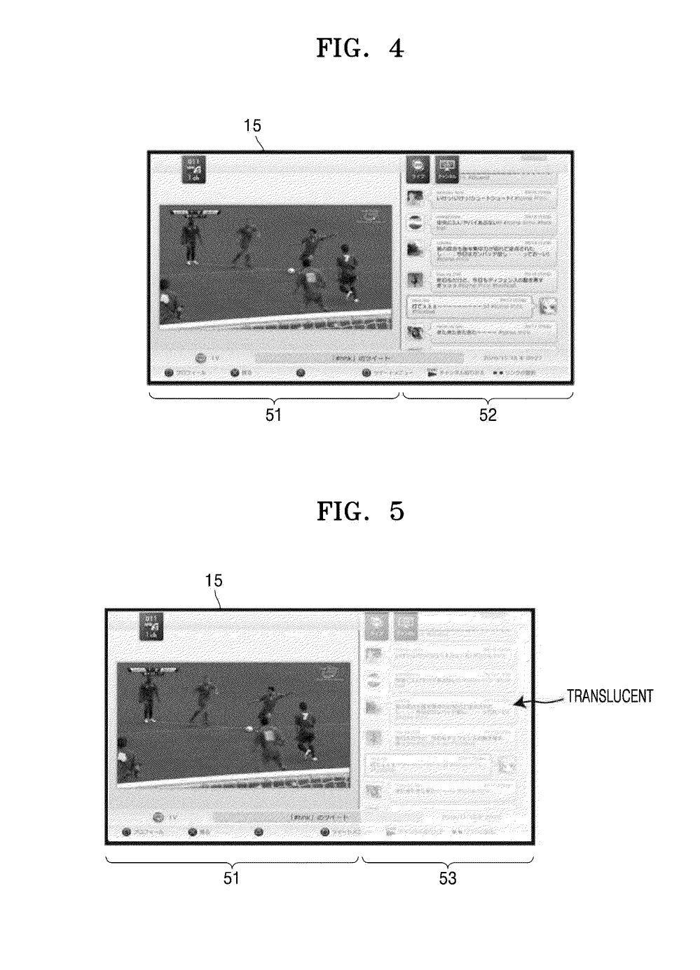

FIG. 3 is a flowchart of an order of a screen conversion process that is executed in the display apparatus 10 (hereinafter, referred to as “screen conversion process”) according to an exemplary embodiment. FIGS. 4 through 7 are screen examples in which the display 15 is converted according to the screen conversion process.

When power is supplied to the display apparatus 10, the display apparatus 10 starts the screen conversion process of FIG. 3.

When the screen conversion process is started, the display apparatus 10 functions as the display control unit 18; controls the broadcast receiver 11, the decoding processing unit 12, and the display processing unit 13; and thus receives a digital broadcast that is transmitted from a broadcasting station and displays the digital broadcast on the display 15 (S101). In S101, the screen that is displayed on the display 15 may be a screen for all users (hereinafter, referred to as “public mode”).

In the public mode, the display apparatus 10 determines whether or not an instruction for displaying the specific data is provided (S102). For example, when the display apparatus 10 receives an instruction for starting an SNS via the operation detection unit 22, the display apparatus 10 determines that the instruction for displaying the specific data has been provided. The instruction for displaying the specific data is not limited to the instruction for starting an SNS. The instruction for displaying the specific data may be an instruction for starting an Internet phone service, such as Skype®, an instruction for starting an application that browses through personal use images or videos, an instruction for displaying operation history, an instruction for displaying login information regarding specific services, an instruction for displaying keyword input history, an instruction for displaying search history of visited sites, an instruction for displaying view history of web pages, an instruction for displaying personal information, such as credit card numbers or passwords, etc. Alternatively, if none of the instructions described above or the like are received, the display apparatus 10 determines that the instruction for displaying the specific data has not been provided.

When the display apparatus 10 determines that the instruction for displaying the specific data has not been provided (S102: NO), the display apparatus 10 continues to display the public mode screen. When the display apparatus 10 determines that the instruction for displaying the specific data has been provided (S102: YES), the display apparatus 10 acquires the specific data via the network interface 23 or by using the specific data storage unit 21. Then, the display apparatus 10 controls the image processing unit 13, and overlaps the acquired specific data on a digital broadcast that is being displayed on the display 15 (S103). The screen that is displayed on the display 15 may be a screen for a specific user watching a digital broadcast (hereinafter, referred to as “private mode”).

For example, as shown in FIG. 4, in the private mode of S103, the display 15 displays an area 51 for all users in which a digital broadcast is displayed, and an area 52 for a specific user in which the specific data is displayed (such as a screen for using SNS).

While the private mode screen is being displayed, the display apparatus 10 determines whether or not a third party other than the specific user watching a digital broadcast approaches the display apparatus 10. For example, the display apparatus 10 may function as the detection unit 19, and may use the microphone 25 to acquire audio such as sound or footsteps of the third party. When audio, which is different from audio that is output from the speaker 16 (for example, louder audio than the audio from the speaker 16), is acquired, the display apparatus 10 determines that the third party may by approaching the display apparatus 10. When audio, which is not different from the audio output from the speaker 16, is acquired, the display apparatus 10 determines that the third party is not approaching the display apparatus 10.

When the display apparatus 10 determines that the third party is not approaching the display apparatus 10 (S104: NO), the display apparatus 10 continues to display the private mode screen. When the display apparatus 10 determines that a third party may be approaching the display apparatus 10 (S104: YES), the display apparatus 10 functions as the display control unit 18, and converts the area 52, which is being displayed on the display 15, into a translucent screen (S105). Accordingly, the specific data that is being displayed in the area 52 may become less visible, and thus the third party may not be able to see the specific data as they are approaching from a distance. In S105, the screen that is being displayed on the display 15 may be a screen that displays the specific data but is on alert of a third party approach (hereinafter, referred to as “alert mode”).

For example, as shown in FIG. 5, in the alert mode of S105, the display 15 displays the area 51 in which a digital broadcast is being displayed as usual, and an area 53 for a specific user, in which the specific data would be displayed, as translucent.

When the alert mode screen is displayed, the display apparatus 10 determines whether or not a third party, other than the specific user watching a digital broadcast, is approaching the display apparatus 10 (S106). For example, the display apparatus 10 functions as the detection unit 19, and uses the camera 24 to photograph the person approaching the display apparatus 10. When a person other than the specific user exists in an image obtained by photography, the display apparatus 10 determines that a third party is approaching the display apparatus 10. When only the specific user is in the image obtained by the photography, the display apparatus 10 determines that a third party is not approaching the display apparatus 10.

When the display apparatus 10 determines that a third party is not approaching (S106: NO), the display apparatus 10 stops converting the area 53 into a translucent screen, and returns the area 53 to display the private mode screen. When the display apparatus 10 determines that a third party is approaching (S106: YES), the display apparatus 10 functions as the display control unit 18, and gradually converts the area 51, in which a digital broadcast is displayed, into a full screen display (S107). Therefore, the area 53, which is translucent, disappears from the display 15, and the area 51 fills the entire screen.

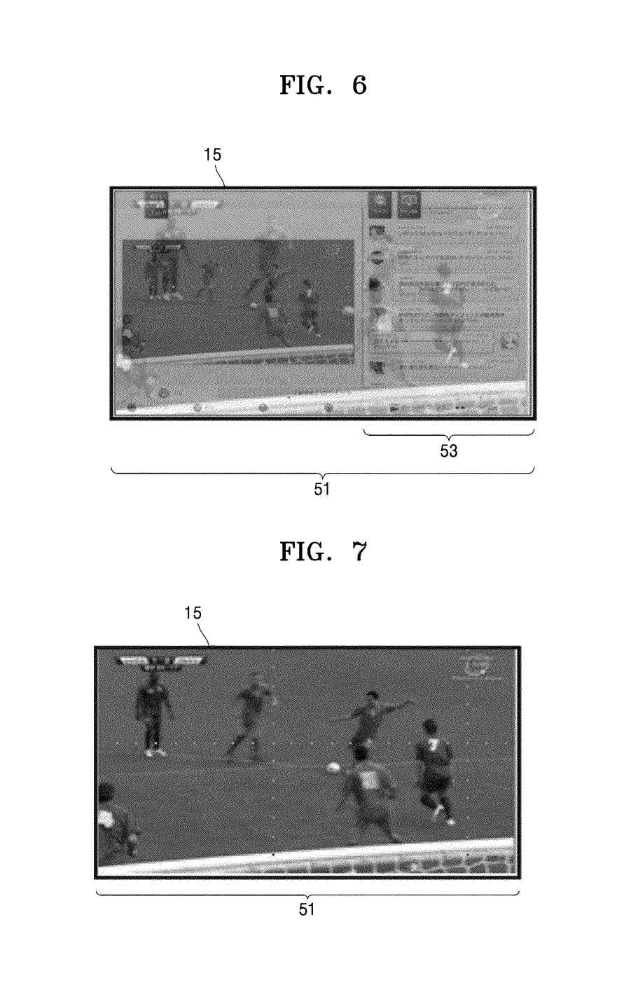

For example, as shown in FIG. 6, when a screen is converted in S107, a transition effect occurs so that the screen may be converted naturally when a third party sees the screen. The screen that is finally displayed on the display 15 hides the specific data so that the specific data is invisible to the third party (hereinafter, referred to as “privacy protection mode”).

For example, as shown in FIG. 7, in the private protection mode of S107, the area 51, in which a digital broadcast is displayed, fills the entire screen, and the specific data is hidden.

When the privacy protection mode screen is displayed, the display apparatus 10 determines whether or not a third party, other than the specific user watching a digital broadcast, has moved away from the display apparatus 10 (S108). For example, the display apparatus 10 functions as the detection unit 19, and uses the camera 24 to photograph. When only the specific user is in an image obtained by photography, the display apparatus 10 determines that a third party has moved away from the display apparatus 10. Also, when a third party, other than the specific user, exists in the image obtained by photography, the display apparatus 10 determines that the third party has not moved away from the display apparatus 10.

When the display apparatus 10 determines that a third party has not moved away from the display apparatus 10 (S108: NO), the display apparatus 10 continues to display the privacy protection mode screen. Otherwise, when the display apparatus 10 determines that a third party has moved away from the display apparatus 10 (S108: YES), the display apparatus 10 does not have to hide the specific data. Thus, the display apparatus 10 functions as the display control unit 18, and returns the privacy protection mode screen to the public mode screen of S101 (a state existing just before a third party is detected).

When an instruction to power off during S101 through S108 is received from a user, the display apparatus 10 prioritizes the instruction and forces the screen conversion process to be finished.

When the screen conversion process described above is executed by the display apparatus 10, the specific data may be hidden when the display apparatus 10 detects a third party while a specific user is watching TV. Therefore, even if a third party unexpectedly appears while a specific user is watching TV, the specific data may be prevented from becoming known to the third party.

The specific data may be gradually hidden according to a distance between a third party and the display apparatus 10, by converting a screen from the private mode to the alert mode, and from the alert mode to the privacy protection mode. Since the privacy protection mode completely hides the specific data, a screen configuration in the privacy protection mode is different from that in the private mode. Thus, a certain amount of time is necessary to return a screen from the privacy protection mode to the private mode. On the other hand, since the specific data is translucently displayed in the alert mode, a screen may be easily returned from the alert mode to the private mode. In this regard, according to the exemplary embodiments described above, the alert mode is provided so that a screen may be instantly returned to the private mode when a third party is definitely not approaching the display apparatus 10 in the alert mode. Accordingly, even when a third party creates a small noise near the display apparatus 10, a screen is not converted to the privacy protection mode. Therefore, a specific user may personally use the display apparatus 10 more conveniently.

The operations of the flowchart are divided according to a main purpose of an operation, so as to facilitate understanding of the display apparatus 10. A method of dividing and naming the operations are not limited thereto. The operations that are executed in the display apparatus 10 may be divided into more processes. Also, more processes may be executed in one operation.

The foregoing exemplary embodiments and advantages are merely exemplary and are not to be construed as limiting. It will be understood by those of ordinary skill in the art that various substitutions, amendments, or modifications may be made to one or more embodiments of the present invention without departing from the spirit and scope of the exemplary embodiments.

For example, according to the exemplary embodiments described above, in the privacy protection mode, a digital broadcast that is being received is displayed on the whole screen to thus hide the specific data. However, a method of hiding the specific data is not limited thereto, and other methods may be used to hide the specific data.

For example, the specific data may be covered with a specific web page (browser 54) and thus be hidden (modified example 1).

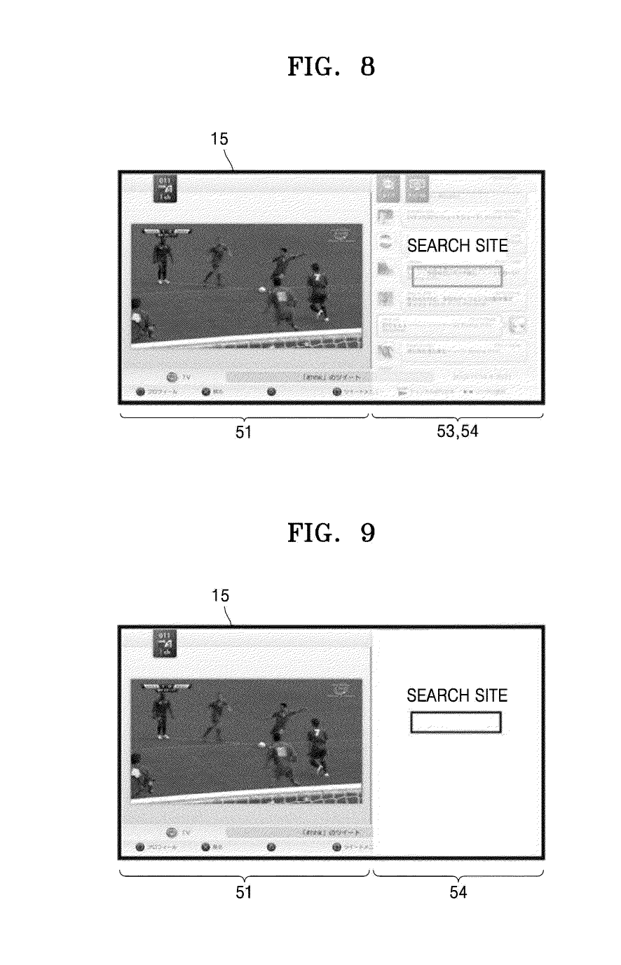

FIGS. 8 and 9 are examples of a screen conversion in which the specific data is hidden by a specific web page according to an exemplary embodiment.

Referring to FIG. 8, when the display apparatus 10 converts a screen from the alert mode to the privacy protection mode, the display apparatus 10 gradually converts the browser 54 that is displaying a specific web page from a transparent state to a complete state, in the area 53 that is translucent in the alert mode. As a result, as shown in FIG. 9, the browser 54 displaying a specific web page (such as a search site) is displayed in the area 53, and replaces the translucent screen in the area 53.

Also, since the broadcast receiver 11 includes a plurality of tuners, the specific data may be hidden by a digital broadcast 55 of a channel other than a digital broadcast that is being displayed in the area 51 (hereinafter, referred to as “digital broadcast 55”) (modified example 2).

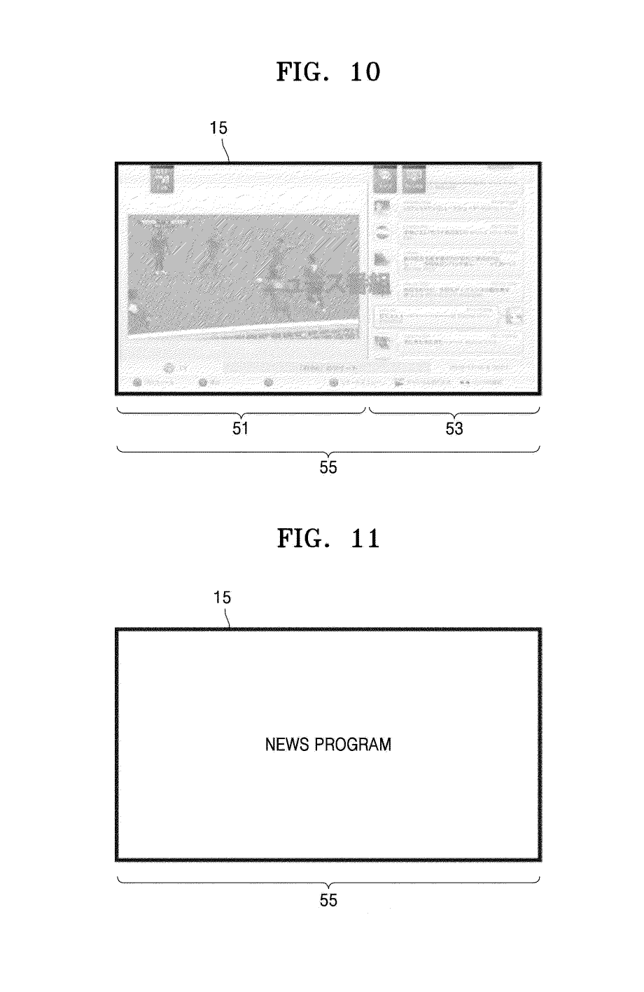

FIGS. 10 and 11 are examples of a screen conversion in which the specific data is hidden by the digital broadcast 55 according to an exemplary embodiment.

Referring to FIG. 10, when the display apparatus 10 converts a screen from the alert mode to the privacy protection mode, the display apparatus 10 gradually converts the digital broadcast 55 (such as a news program), which is being displayed on the whole screen, from a transparent state to a complete state. As a result, as shown in FIG. 11, a digital broadcast that is being displayed in the area 51, and the area 53 that is translucent both disappear; and the digital broadcast 55, which may be seen by a third party, is displayed on the whole screen.

Although not described above, the specific user watching a digital broadcast may move away from the display apparatus 10. In this case, when the detection unit 19 detects that the specific user is no longer watching a digital broadcast, the display apparatus 10 functions as the display control unit 18, and converts a screen of the display 15 into a screen that is hiding the specific data. Therefore, even when a third party appears in front of the display apparatus 10 while the specific user is distanced from the display apparatus 10, the third party may not see the specific data.

Alternatively, the specific user may move away from the display apparatus 10 and return back to the front of the display apparatus 10. In this case, when a specific user return to the display apparatus 10 and is detected by the detection unit 19, the display apparatus 10 functions as the display control unit 18 and converts a screen of the display apparatus 10 from a screen that is hiding the specific data into a screen that is not hiding the specific data. Therefore, as soon as the specific user returns in front of the display apparatus 10, the specific user may immediately use the display apparatus 10 in the private mode.

A screen may be converted to a screen that is hiding the specific data by changing a login state of a specific application or a search site, or the like, to a logout state.

According to the exemplary embodiment described above, a screen is converted in an order of the private mode, alert mode, and privacy protection mode. However, the exemplary embodiments are not limited thereto. When a third party approaches the display apparatus 10, a screen may be directly converted from the private mode to the privacy protection mode.

Also, in S106 of the screen conversion process, the camera 24 is used to determine whether or not a third party is approaching the display apparatus 10. However, the exemplary embodiments are not limited thereto, and detecting results obtained from the various sensors 26, such as an infrared camera, infrared thermography, and a human detection sensor, may be used to determine whether or not a third party is approaching the display apparatus 10.

According to the exemplary embodiments described above, a digital broadcast is displayed in the area 51. However, the exemplary embodiments are not limited thereto. For example, if a third party watches the area 51, the area 51 may display a screen in which a video, a DVD, or a Blu-ray disc (BD) is reproduced, a screen in which images, video, live streaming, or a web page is displayed, or a screen in which a game or various applications being executed.

According to the exemplary embodiments described above, a screen for using SNS is provided as an example in which the specific data is displayed in the area 52. However, the exemplary embodiments are not limited thereto. The specific data that is displayed in the area 52 may be a screen that a specific user does not want a third party to see, such as a screen in which a video, a DVD, or a Blu-ray disc (BD) is reproduced, a screen in which images, videos, live streaming, or a web page is displayed, or a screen in which a game or various applications is being executed.

If the display apparatus 10 is a home appliance, the display apparatus 10 is not limited to a TV. For example, the display apparatus 10 may be a projector that projects an image on a large screen.

Only the main elements of the configuration of the display apparatus 10 are described above. However, the configuration of the display apparatus 10 is not limited thereto, and a general configuration of the display apparatus 10 is not excluded from the spirit and scope of the exemplary embodiments.

The elements of the display apparatus 10 are classified according to a main feature of an element, so as to facilitate the understanding of features of the elements. However, a method of classifying and naming the elements are not limited thereto. The elements may be classified into a greater numbers of elements, according to features of each element. Alternatively, the elements may be classified so that one element may execute more than one process (i.e., classified into a smaller number of elements).

A program for operating the display apparatus 10 may be provided in a computer-readable recording medium, such as a USB memory, a Floppy disc, or a CD-ROM, or provided online via a network such as the Internet. In this case, a program recorded in a computer-readable recording medium is generally transferred to and stored in the memory 172 or the storage 173. Also, the program may be provided as independent application software, or be embedded in software of the display apparatus 10 as a feature thereof.

As described above, according to one or more of the exemplary embodiments, when a third party is detected while a specific user is using the TV, specific data for personal use may be hidden. Thus, even when the third party unexpectedly appears while the specific user is using the TV, the specific data for personal use may be prevented from becoming known to the third party.

While certain exemplary embodiments have been particularly shown and described, it will be understood by those of ordinary skill that various changes in form and details may be made therein without departing from the spirit and scope of the inventive concept as defined by the appended claims.

What is claimed is:

1. A display apparatus comprising:
a display unit configured to display a screen based on specific data of a specific user for personal use;
a detection unit configured to detect a person and determine whether the detected person is the specific user or a third party other than the specific user; and
a display control unit configured to convert the screen of the display unit into a screen hiding the specific data when the third party is detected by the detection unit.

2. The display apparatus of claim 1, further comprising a data management unit configured to manage the specific data for personal use, according to users that have used the display apparatus.

3. The display apparatus of claim 1, wherein the detection unit is configured to register in advance a user that corresponds to the specific use, and determine all non-registered users as the third party.

4. The display apparatus of claim 1, wherein when the third party is no longer detected by the detection unit, the display control unit is configured to return the screen of the display unit to a state existing just before the third party was detected.

5. The display apparatus of claim 1, wherein when the specific user that had been detected by the detection unit is no longer detected, the display control unit is configured to convert the screen of the display unit into the screen hiding the specific data.

6. The display apparatus of claim 5, wherein when the specific user returns and is detected by the detection unit, the display control unit is configured to convert the screen of the display unit from the screen hiding the specific data into a screen not hiding the specific data.

7. The display apparatus of claim 1, wherein the display control unit is configured to gradually convert the screen of the display unit into the screen hiding the specific data according to a distance between the third party and the display apparatus.

8. The display apparatus of claim 1, wherein the display control unit is configured to convert a login state in a specific application or a specific site into one that appears as a logout state, and thus is configured to convert the screen of the display unit into the screen hiding the display data.

9. The display apparatus of claim 1, wherein the specific data includes at least one of operation history, watching history, view history, a web page being displayed, a content being watched, an application being used, a recorded content being reproduced, and personal information.

10. The display apparatus of claim 1, further comprising a plurality of tuners,
wherein when the screen of the display unit is being converted into the screen hiding the specific data, the display control unit is configured to hide the specific data by displaying a digital broadcast of a channel that is tuned by a tuner other than a tuner of the digital broadcast that is being displayed.

11. A non-transitory computer readable medium storing a display program which, when executed by a computer that functions as a display apparatus that displays a screen based on specific data of a specific user for personal use, performs a method comprising:
detecting a person and determining whether the detected person is the specific user or a third party other than the specific user; and
when the third party is detected, converting the screen of the display unit to a display hiding the specific data.

12. The non-transitory computer readable medium of claim 11, wherein the detecting of the specific user and the third party is determined regardless of whether an instruction for displaying the specific data for personal use is provided, and a microphone is used to determine whether the third party other than the specific user is approaching the display apparatus.

13. The non-transitory computer readable medium of claim 11, wherein in the converting of the screen, when the third party is no longer detected in the detecting of the specific user and the third party, the screen of the display apparatus is returned to a state existing just before the third party is detected.

14. The non-transitory computer readable medium of claim 11, wherein in the converting of the screen, when the specific user that had been detected in the detecting of the specific user and the third party is no longer detected, the screen of the display apparatus is converted into the screen hiding the specific data.

15. The non-transitory computer readable medium of claim 14, wherein in the converting of the screen, when the specific user returns and is detected in the detecting of the specific user and the third party, the screen of the display apparatus is converted into a state existing just before the specific user was not detected.

16. The non-transitory computer readable medium of claim 11, wherein in the converting of the screen, the screen of the display unit is converted to the screen hiding the specific data according to a distance between the third party and the display apparatus.

17. The non-transitory computer readable medium of claim 11, wherein in the converting of the screen, a login state in a specific application or a specific site is converted to one that appears as a logout state, and thus the screen of the display unit is converted into the screen hiding the specific data.

18. The non-transitory computer readable medium of claim 13, wherein the specific data includes at least one of operation history, watch history, view history, a web page being displayed, a content being watched, an application being used, a recorded content being reproduced, and personal information.

19. The non-transitory computer readable medium of claim 13, wherein the display apparatus comprises a plurality of tuners,
wherein in the converting of the screen, when the screen of the display apparatus is being converted into the screen hiding the specific data, the specific data is hidden by displaying a digital broadcast of a channel that is tuned by a tuner other than a tuner of the digital broadcast that is being displayed.

20. A method of protecting personal data of a specific user that is displayed on a display device, the method comprising:
displaying the personal data of the specific user on the display device when a third party is not present; and
hiding the personal data of the specific user on the display device when the third party is present.

21. The method of claim 20, wherein the specific user is at least one of a user that is present when the display device is turned on and a registered user.

22. The method of claim 20, further comprising:
displaying public data on the display device;
receiving a request to display the personal data of the specific user on the display device; and
displaying the public data and the personal data on the display device.

23. The method of claim 20, further comprising:
detecting a person approaching the display device;
partially hiding the personal data displayed on the display device;
determining if the detected person is the specific user or the third party; and
returning the display to a state that existed right before the person was detected or hiding the personal data displayed on the display device based on a result of the determination.

24. The method of claim 23, wherein partially hiding the personal data displayed on the display device comprises converting an area of a screen of the display device where the personal data displayed into a translucent screen.

25. The method of claim 20, wherein hiding the personal data displayed on the display device comprises displaying only public data.

26. The method of claim 20, wherein the personal data comprises at least one of operation history, watch history, view history, a web page being displayed, a content being watched, an application being used, a recorded content being reproduced, and personal information.
